(19) United States
(12) Patent Application Publication
(10) Pub. No.: US 2007/0049746 A1
(43) Pub. Date: Mar. 1, 2007

(54) Spherical sulfated cellulose and production process for the same

(75) Inventors: Naoyuki Yoshida, Ichihara-shi (JP); Kazushi Ishida, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO CORPORATION

(21) Appl. No.: 11/513,110

(22) Filed: Aug. 31, 2006

(30) Foreign Application Priority Data
Sep. 1, 2005 (JP) 2005-254121

(51) Int. Cl. C08B 13/00

(52) U.S. Cl. 536/59

(57) ABSTRACT

The invention provides spherical sulfated cellulose which has a high sulfur content and which is excellent for adsorbing proteins, a production process for the same, a protein adsorbing agent containing the above spherical sulfated cellulose and a chromatography apparatus using the same for a filler. More specifically, the invention provides a process for producing spherical sulfated cellulose comprising a step in which spherical cellulose is subjected to at least one sulfate esterification treatment with a mixture of N,N-dimethylformamide and sulfuric anhydride.

### CROSS REFERENCE TO RELATED APPLICATIONS

This application claims priority under 35 U.S.C. § 119 to Japanese Patent Application No. JP 2005-254121, filed Sep. 1, 2005, which application is expressly incorporated herein by reference in its entirety.

### BACKGROUND OF THE INVENTION

1. Field of the Invention

The invention relates to spherical sulfated cellulose, specifically to spherical sulfated cellulose which is useful as a base material for affinity chromatography and a base material for medical use, and a production process for the same.

2. Related Art

Spherical sulfated cellulose is available as a base material which has a group specificity and which is used for separating and refining biological materials such as proteins and virus. Spherical sulfated cellulose is a gelatinous matter obtained by subjecting solid granular particles of cross-linked or non-cross-linked cellulose to sulfate esterification while maintaining a solid granular state thereof and then neutralizing it with alkali. It is known that spherical sulfated cellulose has a biological affinity similar to that of heparin (refer to Japanese Patent Publication No. 23751/1992 and Japanese Patent Publication No. 23752/1992).

However, a sulfur content of spherical sulfated cellulose obtained by conventional methods is as low as about 0.15% (refer to Example 1 in Japanese Patent Publication No. 23751/1992), and an adsorbing ability for protein is not satisfactory.

### SUMMARY OF THE INVENTION

In light of the circumstances described above, it is desired to develop spherical sulfated cellulose having a high sulfur content and which excels for adsorbing proteins, and a production process for the same are desired to be developed.

It has been observed that a content of sulfur introduced into spherical sulfated cellulose is enhanced by using a specific sulfate esterifying agent. That is, the invention provides spherical sulfated cellulose, a production process for the same and a protein adsorbing agent containing the spherical sulfated cellulose and the like which are shown below.

The invention includes the following aspects:

(1) A process for producing spherical sulfated cellulose that includes a step in which spherical cellulose is subjected to sulfate esterification treatment with a mixture of N,N-dimethylformamide and sulfuric anhydride.

(2) The process of item (1), wherein the spherical cellulose is obtained by using crystalline cellulose as a starting material.

(3) The process of item (1) or (2), wherein the spherical cellulose is cross-linked.

(4) The process of any of items (1) to (3), wherein the sulfate esterification treatment is carried out at approximately 0 to approximately 70° C.

(5) The process of any of items (1) to (4) that includes a step in which the spherical cellulose is subjected to dehydration treatment.

(6) The process of item (5), wherein the dehydration treatment is carried out by liquid substitution using a water-soluble solvent.

(7) The process of item (6), wherein the water-soluble solvent contains N,N-dimethylformamide.

(8) The process of any of items (1) to (7) that includes a step in which the spherical cellulose subjected to the sulfate esterification treatment is subjected to neutralization treatment with an alkali.

(9) Spherical sulfated cellulose having a sulfur content of approximately 1% to approximately 10% by weight which can be produced by the process of any of items (1) to (8).

(10) A process for producing spherical sulfated cellulose that includes:

(a) a step in which spherical cellulose is subjected to dehydration treatment by liquid substitution using a water-soluble solvent containing N,N-dimethylformamide;

(b) a step in which the spherical cellulose subjected to the dehydration treatment is subjected to sulfate esterification treatment with a mixture of N,N-dimethylformamide and sulfuric anhydride; and

(c) a step in which the spherical cellulose subjected to the sulfate esterification treatment is neutralized with an alkali.

(11) The process of item (10), wherein the spherical cellulose is obtained by using crystalline cellulose as a starting material.

(12) The process of item (10) or (11), wherein the spherical cellulose is cross-linked.

(13) The process of any of items (10) to (12), wherein the sulfate esterification treatment is carried out at approximately 0 to approximately 70° C.

(14) Spherical sulfated cellulose having a sulfur content of approximately 1% to approximately 10% by weight which can be produced by the process of any of items (10) to (13).

(15) Spherical sulfated cellulose having a sulfur content of approximately 1% to approximately 10% by weight and a sphericity of approximately 0.9 to approximately 1.0.

(16) The spherical sulfated cellulose of item (15) having a sulfur content of approximately 1% to approximately 6% by weight.

(17) A protein adsorbing agent that includes the spherical sulfated cellulose of any of items (9) and (14) to (16).

(18) A filler for affinity chromatography that includes using the protein adsorbing agent of item (17).

According to the process of the invention, spherical sulfated cellulose containing sulfur at a high concentration can be obtained. That is, according to the invention, spherical sulfated cellulose, which is excellent in an adsorbing ability for proteins, can be provided. The spherical sulfated cellulose of the invention is useful as a medical base material for separating and refining various viruses and proteins, and as an adsorbing agent and a filler for chromatography (particularly as a filler for affinity chromatography).

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a graph showing relation of a sulfur content of spherical sulfated cellulose to a lysozyme adsorbing amount.

### DETAILED DESCRIPTION OF THE PREFERRED EMBODIMENTS

The spherical sulfated cellulose, the production process for the same, the protein adsorbing agent and the like according to the invention shall be explained below in detail.

A. Production Process for Spherical Sulfated Cellulose

First, the production process for spherical sulfated cellulose of the invention shall be explained.

The process for producing spherical sulfated cellulose of the invention is characterized by including a step in which spherical cellulose is subjected to sulfate esterification treatment with a mixture of N,N-dimethylformamide and sulfuric anhydride.

In the process of the invention, a mixture of N,N-dimethylformamide and sulfuric anhydride is used as a sulfate esterifying agent for spherical cellulose to subject spherical cellulose to sulfate esterification treatment. A combined matter or a complex which is formed by N,N-dimethylformamide and sulfuric anhydride is contained in the above mixture (refer to the following formula), and it is considered that this works effectively on the sulfate esterification of the spherical cellulose.

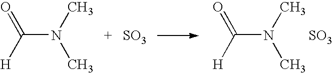

The spherical cellulose used in the invention shall not specifically be restricted, and conventional cross-linked or non-cross-linked spherical cellulose can be used. The spherical cellulose is a solid granular particle having a spherical form, and it is usually gelatinous. The spherical cellulose used in the invention has preferably a sphericity of approximately 0.8 to approximately 1.0. In this case, the “sphericity” means minor diameter/major diameter of the spherical cellulose.

The spherical cellulose described above can be obtained, for example, by dissolving crystalline cellulose or cellulose having a crystalline region and/or an amorphous region and reproducing it. A specific production process for spherical cellulose includes, for example, processes in which it goes through acetic acid esters (described in Japanese Patent Publication No. 39565/1980 and Japanese Patent Publication No. 40618/1980), a process in which it is granulated from a solution using calcium thiocyanate (described in Japanese Patent Publication No. 62252/1988) and a process in which it is produced from a paraformaldehyde dimethylsulfoxide solution (described in Japanese Patent Publication No. 38203/1984). Further, U.S. Pat. No. 3,663,666 describes a process in which it is molded from a cellulose solution obtained by dissolving cellulose in amide containing lithium chloride.

Spherical cellulose obtained by using crystalline cellulose as a starting material is preferably used as the spherical cellulose used in the invention since sulfur can be allowed to be contained at a higher concentration. It is because spherical cellulose originating in crystalline cellulose has a high strength and is less liable to be dissolved in water, so that spherical sulfated cellulose is not softened too much if sulfur is allowed to be contained at a high concentration. Cross-linked spherical cellulose is preferred as the spherical cellulose used in the invention since it has a high physical stability. In particular, cross-linked spherical cellulose obtained by cross-linking spherical cellulose originating in crystalline cellulose is more preferred since it has excellent physical stability. Spherical cellulose is increased in hydrophilicity as sulfate esterification is advanced, so that a spherical form is less liable to be maintained in a certain case. However, use of spherical cellulose having a high physical stability makes it possible to produce spherical sulfated cellulose, which has a high strength and is less liable to be dissolved in water.

Cross-linked spherical cellulose can be produced by subjecting non-cross-linked spherical cellulose to cross-linking treatment. A cross-linking method shall not specifically be restricted as long as it is usually used for cross-linking cellulose. Multifunctional epoxy compounds such as epichlorohydrin can be given as the example of a cross-linking agent.

Commercially available products can also be used as the spherical cellulose used in the invention. The non-cross-linked spherical cellulose includes, for example, Cellufine GC-15®, GH-25®, GC-100® and GC-200® (manufactured by Chisso Corporation) and Avicel® (manufactured by Asahi Chemical Industry Co., Ltd.). The cross-linked spherical cellulose includes Cellufine GCL-25®, GCL-90® and GCL-2000® (manufactured by Chisso Corporation). Further, capable of being used are Viscopearl® (manufactured by Rengo Co., Ltd.) which is commercially available as cellulose particles reproduced from viscose, Perloza MT® series (manufactured by Iontsorb Co., Ltd.) and “Cellulose, Beaded” (catalogue cord C8204, manufactured by Sigma Co., Ltd.).

An average particle diameter of the spherical cellulose used in the invention is preferably approximately 1 to approximately 1,000 μm, more preferably approximately 100 to approximately 500 μm and further preferably approximately 250 to approximately 300 μm. The average particle diameter can suitably be selected according to use applications. When the spherical sulfated cellulose of the invention obtained using spherical cellulose as a starting material is used as a filler for chromatography, for example, the void ratio is enhanced if the average particle diameter is too large, and it tends to be difficult to obtain a certain separative power. On the other hand, if it is too small, pressure is likely to be applied to bring about deformation. Accordingly, an average particle diameter of the spherical cellulose is preferably approximately 50 to approximately 250 μm, more preferably approximately 50 to approximately 125 μm.

On the other hand, when the spherical sulfated cellulose of the invention is used for medical applications, a too small average particle diameter allows blood platelets and blood cells contained in the blood to cause clogging in the voids between the spherical cellulose particles. Therefore, an average particle diameter of the spherical cellulose is preferably approximately 50 to approximately 1000 μm, more preferably approximately 300 to approximately 700 μm.

In the invention, an average particle diameter of the spherical cellulose can be calculated from particle diameters (arithmetic diameter) measured using an electric resistance method. The electric resistance method is a method making use of a change in an electric resistance between two electrodes brought about when particles pass through a sensitive region. Since an electric resistance is proportional to the volume of a particle, a change in the electric resistance is measured and is converted to a particle diameter, whereby a particle diameter of the spherical cellulose can be measured. The whole data of the “arithmetic diameter” values thus measured is averaged to obtain the average particle diameter. A precision particle size distribution measuring apparatus (e.g., a Multisizer 3® manufactured by Beckman Coulter, Inc.) can be used as the measuring apparatus.

The spherical cellulose used in the invention preferably has an exclusion limit molecular weight of 2,000 to 3,000,000. An exclusion limit molecular weight of the spherical cellulose is varied to a large extent depending on a size of protein and virus, which are objects for absorption, and therefore it is suitably determined. In this case, the exclusion limit molecular weight can be determined by filling a column with the spherical cellulose and allowing substances having known molecular weights to flow through it to plot volumes (or elution time) of elution peaks of the respective substances versus the molecular weights. An exclusion limit molecular weight is a molecular weight in which the substances cannot get into pores of the spherical cellulose. An elution volume (or elution time) of a substance having a molecular weight, which is not smaller than the exclusion limit molecular weight, is measured as the same value. Substances which can be used for measurement of an exclusion limit molecular weight having a known molecular weight include proteins, sugars and synthetic polymers such as polyethylene glycols and polyethylene oxides.

Dehydration Treatment

Spherical cellulose usually has a moisture content of about 90% (based on its own weight) even after centrifugal dehydration. When spherical cellulose is subjected to sulfate esterification when a large amount of moisture is present (as described above), the sulfate esterifying agent is deactivated by the moisture and sulfate esterification does not proceed efficiently. Accordingly, in the invention the spherical cellulose is preferably subjected to dehydration treatment before carrying out the sulfate esterification treatment to remove moisture in advance as much as possible.

The dehydration treatment shall not specifically be restricted as long as moisture contained in the spherical cellulose can sufficiently be removed without damaging the form of the spherical cellulose. A dehydration treating method includes, for example, drying by heating and liquid substitution using a water-soluble solvent. Drying by heating can be carried out as well under a vacuum condition.

Drying by heating is convenient as a method for removing moisture, but it can cause shrinkage or breakage of the spherical cellulose under certain circumstances. Accordingly, the liquid substitution in which such shrinkage or breakage are less liable to be brought about is preferably used in the process of the invention. According to the liquid substitution, moisture can be removed in the state that the form of the spherical cellulose is held. In particular, spherical cellulose originating in crystalline cellulose has a low density and is liable to cause shrinkage or breakage by drying by heating, and therefore the liquid substitution is preferably used.

The liquid substitution can be carried out by sufficiently stirring spherical cellulose together with a water-soluble solvent in a vessel, leaving it standing still and then carrying out decantation of the supernatant. Repeating of the above operation makes it possible to sufficiently remove moisture contained in the spherical cellulose. The above operation is repeated until the moisture contained in the supernatant reaches preferably approximately 2% by weight or less, more preferably approximately 1% by weight or less and particularly preferably approximately 0.3% by weight or less to remove the moisture, whereby subsequent sulfate esterification treatment can efficiently be carried out.

The water-soluble solvent used in the invention shall not specifically be restricted as long as it has an affinity for water and does not retard progress of the sulfate esterification treatment. Aprotic organic solvents are preferred as the above water-soluble solvent. The aprotic organic solvents include, for example, acetonitrile, dimethylsulfoxide, N,N-dimethylformamide, N,N-dimethylacetamide, N-methylpyrrolidone, tetrahydrofuran, dioxane, pyridine, triethylamine and piperidine.

Among them, N,N-dimethylformamide that is also used as a sulfate esterifying agent is preferably contained as the water-soluble solvent because the sulfate esterification treatment can more efficiently be carried out. N,N-dimethylformamide is preferably used alone or in a mixed solvent of N,N-dimethylformamide with other water-soluble solvents. In particular, N,N-dimethylformamide is preferably used alone.

Sulfate Esterification Treatment

Next, the sulfate esterification treatment is carried out. First, a mixture of N,N-dimethylformamide and sulfuric anhydride is prepared. A mixing ratio of N,N-dimethylformamide to sulfuric anhydride shall not specifically be restricted as long as it falls in a range in which N,N-dimethylformamide is excessive to sulfuric anhydride. A sulfuric anhydride concentration in the mixture described above is preferably approximately 10% to approximately 30% by weight. If the sulfuric anhydride concentration is within the above range, the sulfate esterification reaction of the spherical cellulose may proceed sufficiently, resulting in ease of sulfur content control. A particularly preferred concentration of sulfuric anhydride in the mixture is approximately 18% by weight. A concentration of sulfuric anhydride can be measured, for example, by adding water to the mixture described above to turn sulfuric anhydride into sulfuric acid and then carrying out neutralization titration with sodium hydroxide. Sulfuric anhydride is reacted with water in a ratio of approximately 1:1, and therefore a concentration (mole concentration) of sulfuric acid measured by the neutralization titration described above means, as it is, a concentration (mole concentration) of sulfuric anhydride.

The mixture of N,N-dimethylformamide and sulfuric anhydride can be prepared by adding sulfuric anhydride dropwise to N,N-dimethylformamide and followed by mixing. Heat can be generated during mixing, and therefore the mixing is preferably carried out at a temperature condition of approximately 5° C. or lower using an ice bath.

Next, the mixture of N,N-dimethylformamide and sulfuric anhydride is added dropwise to a dispersion of the spherical cellulose and N,N-dimethylformamide. In the invention, the mixture of N,N-dimethylformamide and sulfuric anhydride is preferably added dropwise to the dispersion of the spherical cellulose and N,N-dimethylformamide while maintaining a low temperature of approximately 5° C. or lower using, for example, an ice bath in order to carry out the reaction homogeneously.

The sulfate esterification treatment is carried out, for example, by slowly adding the mixture of N,N-dimethylformamide and sulfuric anhydride dropwise to the dispersion of the spherical cellulose and N,N-dimethylformamide which is already in a reaction vessel and then sufficiently stirring them. The above sulfate esterification treatment is carried out preferably at approximately 0 to approximately 70° C., more preferably approximately 0 to approximately 50′ C., further preferably approximately 0 to approximately 35° C. and particularly preferably approximately 0 to approximately 30° C. When coloring of the spherical sulfated cellulose by an amine base solvent is concerned, the sulfate esterification reaction is carried out preferably at approximately 0 to approximately 30° C. The stirring time shall not specifically be restricted as long as it falls in a range in which the sulfate esterification reaction can sufficiently proceed (i.e., usually approximately 1 to approximately 10 hours, preferably approximately 2 to approximately 6 hours and more preferably approximately 2 to approximately 4 hours).

The above method for mixing the spherical cellulose with the mixture of N,N-dimethylformamide and sulfuric anhydride is one example, and it shall not be restricted to the method described above as long as the sulfate esterification reaction can homogeneously be carried out. A use amount of the mixture of N,N-dimethylformamide and sulfuric anhydride is allowed to fall in a range which is necessary and enough for carrying out sulfation of the spherical cellulose, and the range thereof can suitably be determined by persons of average skill in the art. For example, a value obtained by dividing the mass of the spherical cellulose by a molecular weight corresponding to glucose (unit structural substance) is set as a mole number, and a use amount of the above mixture is preferably controlled so that sulfuric anhydride which is approximately 1 to approximately 5 times as much as it is contained. A use amount of the above mixture is controlled so that sulfuric anhydride which is more preferably approximately 1 to approximately 3 times, further preferably approximately 1 to approximately 1.5 times as much as it is contained.

Neutralization Treatment

The spherical cellulose subjected to the sulfate esterification treatment is collected by filtering separation, washed with an alcohol base solvent such as methanol, ethanol and the like and then preferably subjected to neutralization treatment with an alkali.

The neutralization treatment can be carried out by a method usually used in producing spherical sulfated cellulose. It can be carried out, for example, using an aqueous solution or an alcohol solution in which an alkali such as sodium hydroxide, potassium hydroxide and magnesium hydroxide is dissolved.

After the neutralization treatment, the product is washed with ion-exchanged water and the like, and the intended spherical sulfated cellulose can be obtained.

According to the process of the invention, the spherical sulfated cellulose which has a high sulfur content and which has excellent adsorbing ability can be obtained by a simple method.

According to the preferred embodiment of the invention, the process of the invention includes:

(a) a step in which spherical cellulose is subjected to dehydration treatment by liquid substitution using a water-soluble solvent containing N,N-dimethylformamide,

(b) a step in which the spherical cellulose subjected to the dehydration treatment is subjected to sulfate esterification treatment with a mixture of N,N-dimethylformamide and sulfuric anhydride; and

(c) a step in which the spherical cellulose subjected to the sulfate esterification treatment is subjected to neutralization treatment with an alkali. The respective steps have been described above in details, and therefore they shall not repeatedly be explained here.

B. Spherical Sulfated Cellulose

The spherical sulfated cellulose, which can be produced in the manner described above, can contain sulfur at a high concentration. The spherical sulfated cellulose of the invention has a sulfur content of preferably approximately 1% to approximately 10% by weight, more preferably approximately 1% to approximately 6% by weight and further preferably approximately 1% to approximately 4% by weight. In this case, a sulfur content of the spherical sulfated cellulose means a sulfur content of the spherical sulfated cellulose per a dry weight thereof, and it can be measured by means of an inductively coupled plasma method. To be specific, it can be measured by means of an inductively coupled plasma emission spectrometer (model number: IRIS-AP, manufactured by Nippon Jarrel Ash Co., Ltd.), wherein a measuring wavelength of sulfur is set to 182.034 nm. The spherical sulfated cellulose is usually gelatinous, and therefore the spherical sulfated cellulose, which is subjected in advance to decomposition treatment, is used as a sample for measurement.

The spherical sulfated cellulose of the invention is a solid granular particle, which can contain sulfur at such a high concentration as described above while maintaining a spherical form, and the sphericity thereof is preferably approximately 0.9 to approximately 1.0. The sphericity can be determined by observation under a microscope.

An exclusion limit molecular weight and a particle diameter of the spherical sulfated cellulose of the invention shall not specifically be restricted. They are allowed to be suitably determined according to the absorption objects and the uses.

C. Protein-Adsorbing Agent and Uses Thereof

The protein-adsorbing agent of the invention is characterized by containing the spherical sulfated cellulose described above. The protein-adsorbing power is enhanced by containing the spherical sulfated cellulose described above, and therefore the protein adsorbing agent of the invention is suitably used for separating and refining various proteins and viruses.

The protein-adsorbing agent of the invention is useful as a filler for chromatography, such as affinity chromatography, ion exchange chromatography and gel filtering chromatography. In particular, the spherical sulfated cellulose of the invention has a blood coagulation inhibiting action and a lipemia clearing action which are similar to those of heparin. It has a heparin-like group-specific adsorbing power, and therefore use thereof as a filler for affinity chromatography makes it possible to search for proteins to ligands and ligands to proteins and makes it possible to separate and refine these ligands and proteins and antibodies.

The protein adsorbing agent of the invention can also be used as a base material for a blood purifying system for removing virus, low density lipoprotein (LDL), immune complex, bilirubin and endotoxin which are deemed to be disease agents contained in the blood or the blood plasma. When disease agents and the like are removed using the protein adsorbing agent of the invention, removing methods therefore are varied depending on the properties of the disease agents to be removed. For example, endotoxin is not adsorbed on the protein-adsorbing agent of the invention, and therefore the intended substance is allowed to be adsorbed on the protein-adsorbing agent of the column, and then the column is washed well, whereby endotoxin can be removed from the intended substance.

Substances which can be separated and refined using the protein-adsorbing agent of the invention include, for example, heparinase and heparitinase which are heparin degradative enzymes, glycosaminoglycan degradative enzymes, DNA binding proteins (HMG: high mobility group protein, chromatin and histone), bacteriophage, viral vector, Adeno-associated Virus (AAV), Sendai virus, Follistatin, Activin, basic fibroblast growth factor, blood coagulation factor, lipase and nucleic acid degradative enzymes.

### EXAMPLES

The following examples are for illustrative purposes only and are not intended, nor should they be interpreted to, limit the scope of the invention.

### Example 1

Cellufine GH-25® (manufactured by Chisso Corporation) was used as spherical cellulose which was a starting material. This spherical cellulose had a particle diameter of 44 to 105 μm. The above spherical cellulose had an average particle diameter of 67.05 μm and an exclusion limit molecular weight of 2500.

In order to remove moisture contained in the spherical cellulose, 10 g thereof in terms of a moisture weight was weighed in a 50 mL beaker, and 20 mL of N,N-dimethylformamide was added thereto and stirred for 30 minutes. The mixture was left standing still after stirring, and a moisture content of the supernatant was measured by a Karl Fischer's method. This operation was repeated until a moisture content of the supernatant fell in a range of 1% to 2% by weight. Finally, a moisture content of the supernatant reached 1.05% by weight, and therefore the above spherical cellulose subjected to the dehydration treatment was used to carry out subsequent sulfate esterification treatment.

First, the spherical cellulose subjected to the dehydration treatment was dispersed in N,N-dimethylformamide held at 5° C. or lower on an ice bath.

An 18 weight % sulfuric anhydride-dimethylformamide solution (10.97) g cooled to 5° C. was slowly added to the above dispersed solution, and the reaction was carried out for 4 hours while maintaining the reaction temperature at 30±2° C. After finishing the reaction, the reaction solution was separated by filtering, and the resulting cake was washed with methanol. The 18 weight % sulfuric anhydride-dimethylformamide solution was prepared by dropwise adding 278 g of sulfuric anhydride to 2500 g of N,N-dimethylformamide cooled at 5° C. or lower on an ice bath while stirring (hereinafter the same shall apply). In this case, the dropping speed was controlled so that temperature of the solution did not exceed 5° C. Next, the cake was put into ion-exchanged water cooled at 10° C. or lower and neutralized by 1M-NaOH. Then, it was sufficiently washed with ion-exchanged water to obtain spherical sulfated cellulose.

A sulfur content of the spherical sulfated cellulose thus obtained was measured by an inductively coupled plasma method. The spherical sulfated cellulose, which was subjected to pretreatment by the following method, was used for measurement.

First, 20 mg of the spherical sulfated cellulose was weighed in a 100 mL beaker and 10 mL of nitric acid was added into the beaker. Then, the spherical sulfated cellulose was decomposed on a hot plate (250° C.) until the brownish-red color became light. In this case, attention was paid so that it was not dried up. After cooling, 5 mL of nitric acid and 2 mL of perchloric acid were further added thereto, and it was decomposed on the hot plate until white smoke was emitted. Subsequently, after cooling, 10 mL of a 1:1 (volume ratio) hydrochloric acid aqueous solution was added to dissolve the residue, and the volume was adjusted to 100 mL by a measuring flask to prepare a sample for measurement.

An inductively coupled plasma emission spectrometer (model number: IRIS-AP, manufactured by Nippon Jarrel Ash Co., Ltd.) was used for measurement, wherein a measuring wavelength of sulfur was set to 182.034 nm and it was determined that the a sulfur content of the spherical sulfated cellulose was 1.31% by weight.

### Example 2

Cellufine GH-25®, which was the same as used in Example 1, was used as a starting material.

In order to remove moisture, 52.7 g of spherical cellulose (including moisture) was weighed in a 200 mL beaker, and 100 mL of N,N-dimethylformamide was added thereto and stirred for 30 minutes. The mixture was left standing still after stirring, and dehydration treatment was repeated by the same method as in Example 1 until a moisture content of the supernatant fell in a range of 1% to 2% by weight. Finally, a moisture content of the supernatant reached 1.60% by weight. The resulting spherical cellulose subjected to the dehydration treatment was used to carry out subsequent sulfate esterification treatment.

Next, the spherical cellulose subjected to the dehydration treatment was dispersed in N,N-dimethylformamide at a temperature of 5° C. or lower. An 18 weight % sulfuric anhydride-dimethylformamide solution (54.99 g) cooled to 5° C. was slowly added to the above dispersed solution. The reaction was carried out for 4 hours while maintaining the reaction temperature at 30±2° C. After finishing the reaction, the reaction solution was separated by filtering, and a cake was washed with methanol. Then, the cake was put into ion-exchanged water cooled at 10° C. or lower and neutralized by 1M-NaOH. Thereafter, it was sufficiently washed with ion-exchanged water to obtain spherical sulfated cellulose.

A sulfur content of the spherical sulfated cellulose was measured in the same manner as in Example 1 and it was determined that the sulfur content of the spherical sulfated cellulose was 1.81% by weight.

### Example 3

Cellufine® (manufactured by Chisso Corporation) was used as a starting material. Cellufine® was produced the following production steps:

(i) The crystalline cellulose 0.46 kg was added to an aqueous solution containing 60% by weight of calcium thiocyanate (as an anhydride) and was dissolved by heating at 110° C.; (ii) A surfactant is added to the above solution, and the solution was added dropwise to 30 L of o-dichlorobenzene heated in advance at 130 to 140° C. and dispersed by stirring;

(iii) Then, the dispersed solution described above was cooled to 40° C. or lower, and 13 L of methanol was added in order to obtain particles;

(iv) This suspension was separated by filtering, and the particles were washed with 13 L of methanol and separated by filtering. This washing operation was carried out several times; and

(v) The particles were washed with a large amount of water to yield the intended spherical cellulose particles.

The above spherical cellulose had a particle diameter of 44 to 300 μm. It had an average particle diameter of 250 μm and an exclusion limit molecular weight of 3,000,000.

In order to remove moisture contained in the spherical cellulose, 50 g thereof (including moisture) was weighed in a 200 mL beaker and 100 mL of N,N-dimethylformamide was added thereto and stirred for 30 minutes. The mixture was left standing after stirring, and the dehydration treatment was repeated by the same method as in Example 1 until a moisture content of the supernatant fell in a level of 0.2% by weight. Finally, the moisture content of the supernatant reached 0.23% by weight, and the resulting spherical cellulose subjected to the dehydration treatment was used to carry out subsequent sulfate esterification treatment.

First, the spherical cellulose subjected to the dehydration treatment was dispersed in N,N-dimethylformamide held at a temperature of 5° C. or lower on an ice bath. An 18 weight % sulfuric anhydride-dimethylformamide solution (15.10 g) that was cooled to 5° C. was slowly added thereto. The solution was stirred for 4 hours while maintaining the reaction temperature at 30±2° C. After finishing the reaction, the reaction solution was separated by filtering, and the resulting cake was washed with methanol. Then, the cake was neutralized by 1M-NaOH in ion-exchanged water cooled to 10° C. or lower. Thereafter, it was washed with ion-exchanged water to obtain spherical sulfated cellulose. The sulfur content of the spherical sulfated cellulose was then measured in the same manner as in Example 1, and it was determined that the sulfur content of the spherical sulfated cellulose was 2.80% by weight.

### Example 4

Spherical cellulose particles in which a moisture content in the supernatant was 0.21% by weight was obtained by the same method as in Example 3, except that in order to remove moisture contained in the spherical cellulose, 2000 g thereof (including moisture) was weighed in a 5 L beaker and 4 L of N,N-dimethylformamide was used.

The whole amount thereof was used, and a 18 weight % sulfuric anhydride-dimethylformamide solution 375.0 g was used to carry out the sulfate esterification treatment and neutralization treatment in the same manners as in Example 3 to obtain spherical sulfated cellulose. The sulfur content of the spherical sulfated cellulose was measured in the same manner as in Example 1 and it was determined that the sulfur content of the spherical sulfated cellulose was 2.20% by weight.

### Example 5

The same spherical cellulose as that used as a starting material in Example 3 was used and cross-linked by the following method.

The spherical cellulose 176 g was weighed in a separable flask having a volume of 2 L, and heptane and a cationic surfactant (Japanese Pharmacopoeia benzalkonium chloride) were added thereto and stirred for about 30 minutes. Then, the temperature was raised to 30° C., and 0.18 g of sodium boron hydride and 420 mL of a sodium hydroxide aqueous solution adjusted to 5% by weight were added thereto and stirred for 2 hours. Then, the temperature was raised to 40° C., and 60.0 g of epichlorohydrin was added thereto. The temperature was further raised to 50±1° C., and the solution was stirred for 4 hours. Then, the solution was cooled down to about 35° C. and neutralized with acetic acid, and then methanol was added thereto. The reaction solution was separated by filtering, and then the resulting cake was washed (in order) with methanol and water to obtain cross-linked spherical cellulose.

Moisture contained in the cross-linked spherical cellulose was removed by the same method as in Example 3, and the dehydration treatment was carried out until a moisture content of the supernatant reached 0.23% by weight, except that 150 g thereof (including moisture) was weighed in a 500 mL beaker and that 300 mL of N,N-dimethylformamide was used.

Sulfate esterification treatment and neutralization treatment were carried out in the same manner as in Example 3, except that the whole amount of the cross-linked spherical cellulose subjected to the dehydration treatment was used and that an 18 weight % sulfuric anhydride-dimethylformamide solution (47.0 g) was used, whereby spherical sulfated cellulose was obtained. The sulfur content of the spherical sulfated cellulose was measured in the same manner as in Example 1, and it was determined that the sulfur content of the spherical sulfated cellulose was 4.70% by weight.

Each 1000 particles of the spherical sulfated celluloses obtained in Examples 1 to 5 were observed under a microscope and measured for a major diameter (R1) and a minor diameter (R2) to determine a sphericity (R2/R1) to find that a sphericity of the respective particles was 0.9 or more, and it was confirmed that a spherical form was held.

Next, in Examples 6 to 10, the spherical sulfated celluloses obtained in Examples 1 to 5 were measured for a lysozyme adsorbing amount.

### Example 6

First, the spherical sulfated cellulose obtained in Example 1 was measured for a lysozyme adsorbing amount by the following method:

The spherical sulfated cellulose 3 g which was stored in methanol and obtained by filtering under reduced pressure was put in a beaker, and 100 mL of ion-exchanged water was added thereto. The mixture was stirred for 10 minutes by means of a magnetic stirrer and then separated by filtering. Treatment in which the above spherical sulfated cellulose separated by filtering was returned again to the beaker and in which 100 mL of ion-exchanged water was added thereto to stir and separate the mixture by filtering was repeated further three times.

The above spherical sulfated cellulose was then put in a beaker, and 100 mL of adsorbing buffer was added thereto and stirred for one hour. A 0.01M phosphoric acid (Na-Na) buffer solution (pH 7.0) containing 0.15 M sodium chloride was used for the adsorbing buffer. Then, 2 mL of the spherical sulfated cellulose suspended in the adsorbing buffer was filled in a column, and the adsorbing buffer was allowed to flow at a flow velocity of 40 mL/hour to equilibrate the column. Subsequently, 30 mL of a prepared solution obtained by adding the adsorbing buffer to 333 mg of a lysozyme solution (Lysozyme®, manufactured by Wako Pure Chemical Industries, Ltd.) was added to adjust the volume to 100 mL and was circulated at a flow velocity of 60 mL/hour for one hour.

Subsequently, 20 mL of the adsorbing buffer was allowed to flow at a flow velocity of 50 mL/hour to remove any non-adsorbed lysozyme. Then, 50 mL of eluting buffer was allowed to flow at a flow velocity of 50 mL/hour, and 45 mL was collected. The eluting buffer (5 mL) was added to the above collected solution to bring the volume to 50 mL, and this solution was set as an eluted solution. A 0.01 M phosphoric acid (Na-Na) buffer solution (pH 7.0) containing 0.6 M sodium chloride was used for the eluting buffer.

A solution obtained by taking 1 mL of the lysozyme solution and adding the eluting buffer to it to make the volume 10 mL was prepared, and this solution was set as a standard solution.

The absorbances of the eluted solution and the standard solution were measured with the eluting buffer set as a control. Measurement was carried out at a wavelength of 280 nm using a quartz cell. The measured numerical values were substituted for the following calculating equation to calculate a lysozyme adsorbing amount:
Adsorbing amount (mg/mL)=0.333×25×(absorbance of the eluted solution/absorbance of the standard solution)
As a result thereof, the adsorbing amount was determined to be 18 mg/mL.

### Example 7

A lysozyme adsorbing amount of the spherical sulfated cellulose obtained in Example 2 was measured in the same manner as in Example 6 to result in finding that the adsorbing amount was 24 mg/mL.

### Example 8

A lysozyrme adsorbing amount of the spherical sulfated cellulose obtained in Example 3 was measured in the same manner as in Example 6, except that after removing non-adsorbed lysozyme, 150 mL of the eluting buffer was allowed to flow to collect 145 mL and that 5 mL of the eluting buffer was added to the collected solution to make the volume 150 mL to prepare an eluted solution. As a result thereof, the adsorbing amount was 39.06 mg/mL.

### Example 9

A lysozyme adsorbing amount of the spherical sulfated cellulose obtained in Example 4 was measured in the same manner as in Example 8. As a result thereof, the adsorbing amount was 26.41 mg/mL.

### Example 10

A lysozyme adsorbing amount of the spherical sulfated cellulose obtained in Example 5 was measured in the same manner as in Example 8. As a result thereof, the adsorbing amount was 40.33 mg/mL.

### Comparative Example 1

Cellufine Sulfate® (manufactured by Chisso Corporation) was used as a sample to measure a lysozyme adsorbing amount in the same manner as in Example 6. As a result thereof, the adsorbing amount was 5 mg/mL. A sulfur content of the Cellufine Sulfate® was measured in the same manner as in Example 1 to find that the sulfur content was 0.16% by weight.

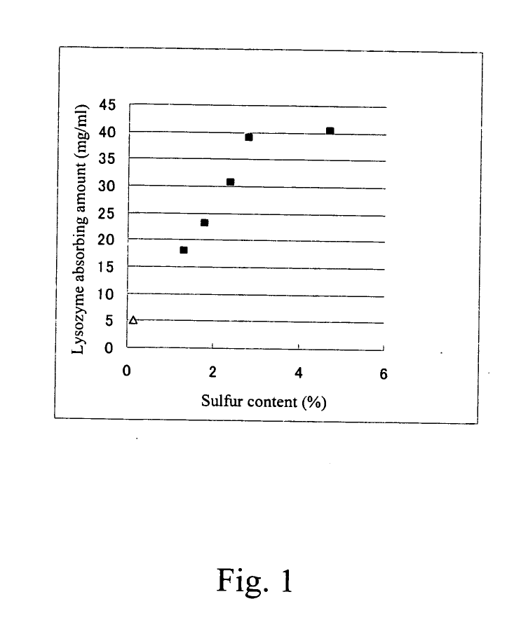

Shown in FIG. 1 is a relation of the sulfur contents of the spherical sulfated celluloses obtained in Examples 6 to 10 and Comparative Example 1 to the lysozyme adsorbing amounts thereof. In FIG. 1, the results obtained in Examples 6 to 10 were shown by “▪,” and the result obtained in Comparative Example 1 was shown by “Δ.” It was found that the spherical sulfated celluloses produced by the process of the invention had a three times or greater lysozyme adsorbing capacity than those of conventional products.

Next, in Example 11, the adsorbing amounts in the blood coagulation VIII factor activity of the spherical sulfated cellulose obtained in Example 3 and Cellufine Sulfate® (manufactured by Chisso Corporation) were compared.

Further, in Example 12, the adsorbing amounts of the blood coagulation XII factor activity of the spherical sulfated cellulose obtained in Example 3 and Heparin Sepharose 6 Fast Flow® (manufactured by Amersham Biosciences K. K.) were compared.

### Example 11

Human plasma (pool) (anticoagulant: sodium citrate, manufactured by Cosmo Bio Co., Ltd.) 6 mL was weighed and put in spitz tubes. Spherical sulfated cellulose (2 mL) obtained in Example 3, which was washed with a physiological salt solution, was added into one of the spitz tubes and 2 mL of Cellufine Sulfate® (manufactured by Chisso Corporation), which was washed with a physiological salt solution, was added into the other spitz tube. Each spitz tube was then stirred at 25° C. for 2 hours by shaking. Then, both were subjected to centrifugal separation, and each supernatant was sampled to measure the adsorbing amount of the blood coagulation VIII factor activity. Plasma to which the gel was not added was used as a blank.

Each blood coagulation VIII factor activity was measured by Mitsubishi Chemical BCL according to an APTT (activated prothrombin time) method. The measured value was shown by a relative value, wherein the measured value of standard human plasma was set to 100%. The adsorbing amount was calculated according to the following equation:
Adsorbing amount (%/mL-gel)=((blank measuring value×volume)−(sample measuring value ×volume))/2

The results thereof are shown in Table 1.

TABLE 1

| | VIII factor activity |
|---|---|
| | adsorbing amount |
| Sample | %/mL-gel |
| Cellufine Sulfate ® | 35 |
| Spherical Sulfated Cellulose of | 191 |
| Example 3 | |

It was found that the spherical sulfated cellulose prepared in Example 3 had an about 5.5 times larger adsorbing capacity than that of Cellufine Sulfate®.

### Example 12

The same operation as in Example 11 was carried out to compare the adsorbing amount of the blood coagulation VII factor activity, except that Heparin Sepharose 6 Fast Flow® (manufactured by Amersham Biosciences K. K.) was used as comparison in place of Cellufine Sulfate® (manufactured by Chisso Corporation).

The blood coagulation XII factor activity was measured by Mitsubishi Chemical BCL according to the APTT (activated prothrombin time) method. The measured value was shown by a relative value, wherein the measured value of standard human plasma was set to 100%. The adsorbing amount was calculated according to the same equation as in Example 11. The results thereof are shown in Table 2.

TABLE 2

| | XII factor activity |
|---|---|
| | adsorbing amount |
| Sample | %/mL-gel |
| Heparin Sepharose 6 Fast Flow ® | 86 |
| Spherical Sulfated Cellulose of | 244 |
| Example 3 | |

It was found that the spherical sulfated cellulose prepared in Example 3 had a 2.8 times or greater adsorbing capacity than that of Heparin Sepharose 6 Fast Flow®.

Next, in Example 13, compared were the adsorbing amounts γ-globulin of the spherical sulfated cellulose prepared in Example 2 or 3, Cellufine Sulfate® and Heparin Sepharose 6 Fast Flow® were compared.

### Example 13

Each 4 mL of the spherical sulfated cellulose prepared in Example 2 or 3, Cellufine Sulfate® and Heparin Sepharose 6 Fast Flow® was filled in separate columns (7 mm×100 mm), and an adsorbing buffer was allowed to pass at a flow velocity of 20 mL/hour to equilibrate each column. Hereinafter each solution was allowed to pass at a flow velocity of 20 mL/hour. A 0.08 M sodium acetate-hydrochloric acid buffer solution (pH 3.5) was used for the adsorbing buffer.

A γ-globulin solution (solution prepared by dissolving Bovine γ-Globulins® (manufactured by Biochemical Industry Co., Ltd.) in adsorbing buffer) 20 mL was allowed to pass through each of the above columns. Then, the adsorbing buffer was allowed to pass to remove non-adsorbed matters.

Next, each was eluted with eluting buffer, and each solution was set as an eluted solution. A 0.08M sodium acetate-hydrochloric acid buffer solution (pH 3.5) containing 0.6 M-NaCl was used for the eluting buffer. The absorbances of each eluted solution and the standard solution (a prepared solution obtained by adding the adsorbing buffer to 1 mL of the γglobulin solution to make the volume 50 mL) were then measured with the eluting buffer set as a control. Measurement was carried out at a wavelength of 280 nm using a quartz cell. The measured numerical values were substituted for the following calculating equation to calculate the γ-globulin adsorbing amounts.
Adsorbing amount (mg/mL)=100×(absorbance of the eluted solution/absorbance of the standard solution)

The results thereof are shown in Table 3.

TABLE 3

| | γ-Globulin |
|---|---|
| | adsorbing amount |
| Sample | (mg/mL) |
| Spherical Sulfated Cellulose of | 18.02 |
| Example 2 | |
| Spherical Sulfated Cellulose of | 51.58 |
| Example 3 | |
| Cellufine Sulfate ® | 0.10 |
| Heparin Sepharose 6 Fast Flow ® | 13.94 |

### INDUSTRIAL APPLICABILITY

The spherical sulfated cellulose of the invention is useful as a medical base material for separating and refining various viruses and proteins, an adsorbing agent and a filler for chromatography.

Although the invention has been described and illustrated with a certain degree of particularity, it is understood that the present disclosure has been made only by way of example, and that numerous changes in the conditions and order of steps can be resorted to by those skilled in the art without departing from the spirit and scope of the invention.

What is claimed is:

1. A process for producing spherical sulfated cellulose comprising the step of subjecting spherical cellulose to a sulfate esterification treatment comprising a treatment with a mixture of N,N-dimethylformamide and sulfuric anhydride.

2. The process according to claim 1, wherein the spherical cellulose is obtained by using crystalline cellulose as a starting material.

3. The process according to claim 1, wherein the spherical cellulose is cross-linked.

4. The process according to claim 1, wherein the sulfate esterification treatment is carried out at approximately 0 to approximately 70° C.

5. The process according to claim 1, further comprising a step in which the spherical cellulose is subjected to dehydration treatment.

6. The process according to claim 5, wherein the dehydration treatment is carried out by liquid substitution using a water-soluble solvent.

7. The process according to claim 6, wherein the water-soluble solvent contains N,N-dimethylformamide.

8. The process according to claim 1, further comprising a step in which the spherical cellulose subjected to the sulfate esterification treatment is subjected to neutralization treatment with an alkali.

9. Spherical sulfated cellulose having a sulfur content of approximately 1 to approximately 10% by weight wherein the spherical cellulose is produced by the process according to claim 1.

10. The spherical sulfated cellulose according to claim 9, wherein the spherical cellulose has a sphericity of approximately 0.9 to approximately 1.0.

11. A process for producing spherical sulfated cellulose comprising:
(a) subjecting spherical cellulose to a dehydration treatment comprising a liquid substitution using a water-soluble solvent containing N,N-dimethylformamide,
(b) subjecting the spherical cellulose previously subjected to the dehydration treatment to a sulfate esterification treatment comprising treatment with a mixture of N,N-dimethylformamide and sulfuric anhydride and
(c) neutralizing the spherical cellulose previously subjected to the sulfate esterification treatment with an alkali.

12. The process according to claim 11, wherein the spherical cellulose is obtained by using crystalline cellulose as a starting material.

13. The process according to claim 11, wherein the spherical cellulose is cross-linked.

14. The process according to claim 11, wherein the sulfate esterification treatment is carried out at approximately 0 to approximately 70° C.

15. Spherical sulfated cellulose having a sulfur content of approximately 1% to approximately 10% wherein the spherical cellulose is produced by the process according to claim 10.

16. The spherical sulfated cellulose according to claim 15, wherein the spherical cellulose has a sphericity of approximately 0.9 to approximately 1.0.

17. Spherical sulfated cellulose having a sulfur content of approximately 1 to approximately 10% by weight and a sphericity of approximately 0.9 to approximately 1.0.

18. The spherical sulfated cellulose according to claim 15, wherein the spherical cellulose has a sulfur content of approximately 1% to approximately 6% by weight.

19. A protein adsorbing agent comprising the spherical sulfated cellulose, wherein the spherical sulfated cellulose is prepared according to claim 9.

20. The protein adsorbing agent according to claim 19, wherein the protein adsorbing agent is used for affinity chromatography.
